(19) United States
(12) Patent Application Publication
(10) Pub. No.: US 2009/0037268 A1
(43) Pub. Date: Feb. 5, 2009

(54) Relevance Engine for Delivering Increasingly Relevant Content to Users

(76) Inventors: Sam Zaid, Ottawa (CA); Paul Lem, Ottawa (CA)

Correspondence Address: J. GORDON THOMSON, P.O. BOX 8865, VICTORIA, BC, V8V 3Z1, CA

(21) Appl. No.: 11/833,201

(22) Filed: Aug. 2, 2007

(51) Int. Cl. G06Q 10/00; G06F 17/40

(52) U.S. Cl. 705/14

(57) ABSTRACT

An electronic means for delivering increasingly relevant advertising content to users comprises a relevance engine a user enrollment portal so that the user can submit relevant user preference information to the engine, means for determining relevant advertising content to be delivered to the user based on submitted user preferences and use preferences learned by the engine, and, means for adjusting the relevance of advertising content delivered to the user based on user responses to the ads delivered.

### BACKGROUND OF THE INVENTION

Many advertisers seek to deliver relevant content to Internet users based on user preferences and surfing habits. However known methods fail to deliver adequately personalized advertising content to Internet users and therefore user participation diminishes over time.

My invention is a relevance engine for delivering increasingly relevant content to Internet users over time. My invention is adaptable to computers as well as cell-phones. PDAs and other similar wireless devices. It is a push-based content delivery means in which the user can passively receive desired content without having to surf and search the Internet. The invention also provides an incentive system for the user to view advertising material by offering tickets for lifetime prize draws. The relevance engine learns and predicts the user's ad preferences such as frequency of viewing ads, the viewer's interests, and the time of day for viewing ads. A novel aspect of my invention is that the relevance engine acts like an adjustable digital valve that controls the rate of advertising delivered to the user. The frequency of ads sent to the user is controlled by the user's preferences and the relevance of the information carried in the ads.

My invention has a number of advantages which contribute to its novelty and inventiveness.
(1) My relevance engine provides an electronic means for delivering increasingly relevant advertising content directly to the user;
(2) It provides a means for tracking the user's ad content preferences;
(3) It provides means for an interactive relationship with the user whereby the user can relate content preferences either directly or indirectly;
(4) It permits the delivery of increasingly relevant ad content to the user over time based on the user's increasingly precise ad content preferences;
(5) It provides for the potential for a single-source intermediary between third-party content providers and the user. This provides increased security, privacy, and convenience to the users because the user only has to contribute information to the system once, instead of multiple times for multiple content providers
(6) It provides a means for delivering content, tracking content preferences, interaction with the user and the delivery of increasingly relevant content to the user in a highly automated, scaleable manner;
(7) It reduces operating costs of content delivery systems and reduces the amount of labor necessary to manage them.

### DESCRIPTION OF THE DRAWINGS

FIG. 1 illustrates a sample user synaptic map.

FIG. 2 illustrates a sample ad synaptic map.

FIG. 3 illustrates a sample advertiser synaptic map.

FIG. 4 illustrates a sample label synaptic map.

FIG. 5 illustrates a sample user synaptic map evolution.

FIG. 6 illustrates a virtual user synaptic map.

FIG. 7 illustrates another user synaptic map.

FIG. 8 illustrates another advertiser synaptic map.

FIG. 9 illustrates yet another advertiser synaptic map.

### DETAILED DESCRIPTION

The Relevance Engine

One novel aspect of my invention is the “relevance engine”. The relevance engine is digital means that learns and predicts the user's ad content preferences based upon accumulated data about the user. There is an enrollment means whereby the user is able to submit personal demographic information such as age, sex and occupation; explicit preferences as to ad content; and, a set of participant-generated taxonomic keywords or a “folksonomy” tags to attract relevant content for the user. There is also a system recordal means that monitors and records data relating to the user's dynamic response to delivered content, for example, click-through rates, response time and time of day. The user is also able to weight ads according to relevance by clicking through to the ad, viewing the ad and then rating the ad's relevance. Therefore the relevance engine is rule-based to predict user preferences and uses a degree of artificial intelligence to refine the predictions of user preferences. With the relevance engine, the user is able to receive increasingly relevant content over time which promotes continued and increased participation in the system. The relevance of content to the user can be determined in a number of ways. For example, the user may wish information on consumer goods and so content that falls into the category of consumer goods is relevant to the user. If the user is interested in information about a particular location then the relevant content is categorized based on the geographic or special nature of the user's interest. Finally, if the user is interested in making a purchase of, say a house, in a certain location and within a certain time frame then the category is classified as to goods as well as to the special and temporal nature of the requirement.

In another embodiment of my invention there is included a reward system for viewing and interacting with the delivered content. One example of an award system is the awarding of points that can be redeemed for material goods or goods having extrinsic or intrinsic value. Another embodiment of the reward system would a prize draw system that would award tickets that would not expire. The number of tickets would continue to accumulate over time thereby incentivising the user to continue to use the system over the long term. This in effect is a lifetime lottery.

Various explanatory samples of my invention follow.

### EXAMPLE 1

### Relevance Engine

Description

The relevance engine may consist of the following components;
(1) A collaboratively generated open-ended natural language taxonomy (“folksonomy”) of labels.
(2) A clustering mechanism for creating groups of labels (“taxons”).
(3) A set of identity labels that uniquely represent identities in the system (“identity elements”), such as users, ads, and advertisers.
(4) A map of weighted relationships between labels, taxons, and/or identity elements (“synaptic map”),
(5) A set of synaptic maps between labels and taxons (“label synaptic maps”).
(6) A set of synaptic maps between users and labels or taxons (“user synaptic maps”)
(7) A set of synaptic maps between ads and labels or taxons (“lad synaptic maps”).
(8) A set of synaptic maps between advertisers and labels or taxons (“advertiser synaptic maps”).
(9) An algorithm for computing the degree of resonance between two or more synaptic maps (“resonance algorithm”).
(10) An electronic mechanism for inputting ad synaptic maps
(11) An electronic mechanism for inputting user synaptic maps.
(12) An electronic or physical mechanism for delivering ads to users, based on resonance between ad synaptic maps and user synaptic maps.
(13) A set of feedback mechanisms for capturing the response of a user to a delivered ad.
(14) A set of learning algorithms for deriving, updating, and adjusting all synaptic maps based on new inputs and based on feedback inputs.
(15) A lottery system that rewards users for providing feedback to the system.

Inputs to the System

The system takes the following inputs:
(1) A set of user synaptic maps.
(2) A set of ad synaptic maps.

Outputs from the System

It generates the following from those inputs:
(1) A set of label synaptic maps
(2) User Synaptic Maps.

User Synaptic Map

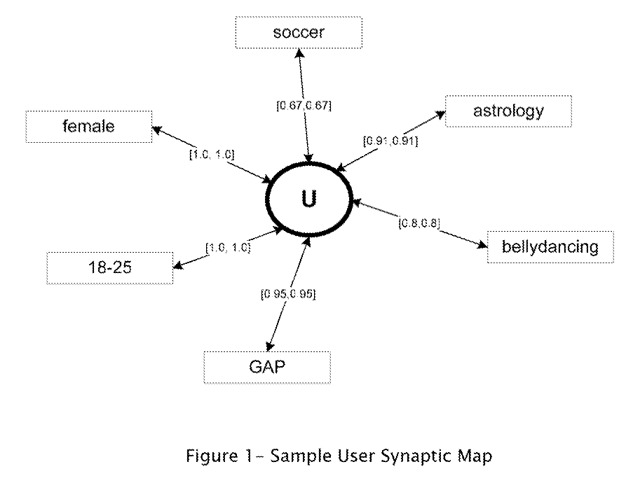

A User Synaptic Map is set of labels tied to a unique identity element representing a user. A user synaptic map looks like FIG. 1 and can be explained as follows:

FIG. 1 relates a user identity (shown as “U”) to a set of folksonomy elements (labels or taxons). At least one map is created for each user of the system. An ad map is generated for each user at signup and continues to exist and track that user as she uses the system.

Each relation consists of a synaptic weight that ranges from 1.0 to +10.0. A synaptic strength >0 is excitory while a strength <0 is inhibitory. The relation weight is represented as a 2-dimensional vector where each dimension represents the synaptic strength in a one direction (U to label, or label to U).

The map is developed through a number of methods:
(1) Using explicit specification by the user. E.g. user specifies labels of interest.
(2) Through resonance with a label synaptic map. E.g. extending existing labels by extracting label similarities.
(3) Via explicit feedback provided by the user in response to an ad. E.g. a user indicates the value of an ad after viewing it.
(4) Via implicit feedback provided by the user in response to an ad. E.g. by incorporating a user's behavior in response to an ad.
(5) => An ignored ad is likely not of value to the user.

User Synaptic Maps enable the system to learn correlations between user interests. In the example above, there may exist a correlation between users that have an interest in “soccer” and users that have an interest in “bellydancing”.

Ad Synaptic Map

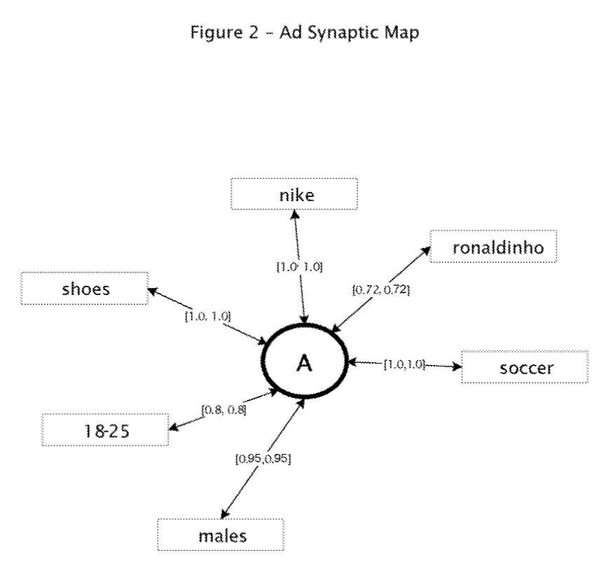

An Ad Synaptic Map is a set of labels tied to a unique identity element representing an ad. An ad synaptic map looks like FIG. 2 and is explained as follows:

FIG. 2 relates an ad identity (shown as “A”) to a set of folksonomy elements. At least one map is created for each ad in the system.

An ad map is generated for each ad input into the system. An ad map is developed through any or all of the following methods:
(1) Inferring labels from ad context by scanning the ad for textual or image content
(2) Receiving input from user(s) of the system as to the context of the ad.
(3) Deriving related labels by relating with a label synaptic map.

As an ad is delivered to users of the system, synaptic weights are adjusted based on the responses of those users. When user responses resonate highly with the synaptic map, weights are strengthened. When user responses do not resonate highly, they are weakened.

Ad Synaptic Maps enable the system to learn synonyms and similarities about things. In the example above, “nike” and “shoes” have a strong similar relation.

Advertiser Synaptic Map

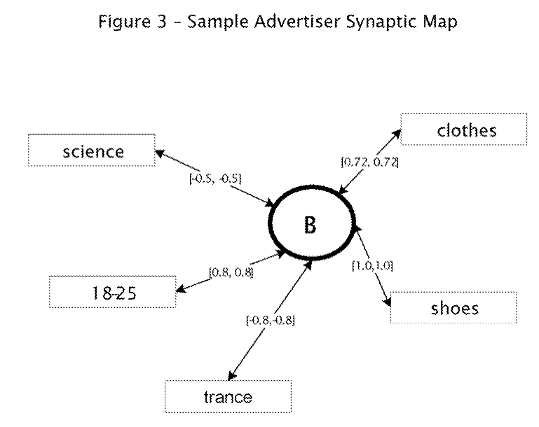

An Advertiser Synaptic Map is built up over successive ad synaptic maps that correspond to the same advertiser. The synaptic strengths in the map depend on the similarity or resonance of ads from that advertiser. An Advertiser Synaptic Map looks like FIG. 3.

An advertiser synaptic map is principally used to suggest labels when new ads are inputted for a known advertiser.

Label Synaptic Map

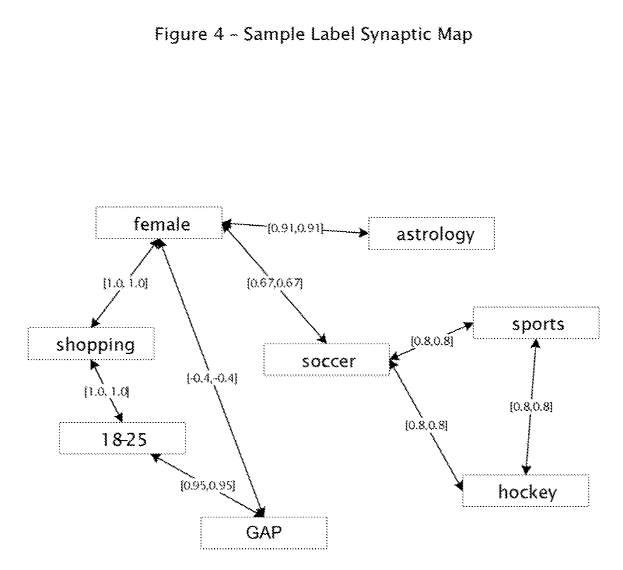

A Label Synaptic Map is derived from large sets of user and ad synaptic maps. Based on commonly occurring relations and correlations of labels, a label synaptic map is learned. It principally answers the question on how labels are related. A label synaptic map is shown in FIG. 4.

Label synaptic maps learn from every (1) ad entered, (2) new users (3) existing user changes and (4) ad response.

A label synaptic map has the advantage that it follows a natural associative memory model.

Label synaptic maps can be enhanced further by clustering them into groups based on semantic relations. For example, all consumer brands would be clustered into one group based on analyzing similarities in their map structure.

Label synaptic maps can also be polymorphic based on a particular attribute. For example, a synaptic map could be geospatially sensitive in that its structure would be different in the US than in Canada. Synaptic relations to the brand “Tim Hortons”, which does not exist in the US, would cause a polymorphic map.

Labels can also be associated into a multi-dimensional, nonlinear hierarchy so that all types of sports would be classified under the label “sports”. By the same token, sports might be classified under the label “Nike”. However, “Nike” might be classified under the label “basketball” which is also under the label “sports”. This creates a circular hierarchy but one that is in fact acceptable and desirable.

Learning and Feedback

All synaptic map weights are modified when any one of the following activities occurs:
(4) Label Synaptic Maps are modified through periodic resonance with,
   a. All or subset of user synaptic maps; and,
   b. All or subset of ad synaptic maps.
   User Synaptic Maps are modified by,
(1) Periodic resonance with Label Synaptic Maps.
(2) Resonance with Ad Synaptic Maps in response to ads.
(3) Positive resonance with viewed ads.
(4) Negative resonance with ignored ads.
(5) By direct feedback from the user.
(6) General click-stream obtained internally from the system
(7) General click-stream obtained externally (e.g. Google search history, traffic stream).
(8) System website browse, navigation, and search history.
(9) User behavior in response to ads, page views, page view duration.
(10) External repositories of user information (e.g. Del.icio.us bookmarks, blogs, social networks).

Ad Synaptic Maps are modified by:
(1) Periodic resonance with Label Synaptic Maps.
(2) Resonance with User Synaptic Maps in response to ads.
(3) Positive resonance with viewed ads.
(4) Negative resonance with ignored ads.
(5) By direct feedback from the advertiser.

Advertiser Synaptic Maps are modified by:
(1) Periodic resonance with all or subset of Ad Synaptic Maps.

Mathematical Model

The relevance engine defines two algorithms for determining relevance, including (1) a learning algorithm, and (2) a resonance algorithm.

The learning algorithm builds upon principles of unsupervised, auto-associative, and hetero-associative learning principles derived from the artificial intelligence domain.

The resonance algorithm builds upon the concepts of mechanical resonance in physics, and applies algorithms from statistics and fuzzy logic in the model.

Mathematical Model—Resonance Algorithm

The resonance algorithm computes the similarity between two synaptic maps, principally a user synaptic map and an ad synaptic map. This is illustrated mathematically in Dirac bracket notation to facilitate readability in this section.

Each user has a minimum of two (2) synaptic maps that can be represented in vector form. One for hard preferences (initially specified explicitly by the user) and one for soft preferences (learned implicitly from user behavior and other implicit sources).

Let I uᵢ^{H}>=(w₁, w₂, w₃, . . . ) be the hard synaptic map for user i

Where the vector has one dimension for each label known in the system

And where vector entires wₖ represent the synaptic weight to each label for user i.

For hard maps: wₖ can take one of three values in the set {−1,0,+1}

Similarly, let I uᵢ^{S}> be the soft synaptic map for user i.

For soft maps: wₖ can be any real value [−1,+1]

Note that these vectors are necessarily sparse.

Each ad also has a minimum of two (2) synaptic maps that can be represented in vector form. One for hard preferences (initially specified when the ad in inputted into the system by either by a machine or a human) and soft preferences (learned implicitly from user behavior and other implicit sources),
Let Ia^{H}ⱼ> and Ia^{S}ⱼ> be the hard and soft synaptic maps for ad j respectively

With one dimension for each label known in the system

The generalized similarity of user i to ad j can be computed as follows,

Sᵢⱼ=1/Nₐ<u^{H}ᵢ+u^{S}ᵢIa^{H}ⱼ+a^{S}ⱼ>

Where Nₐ=the number of nonzero entries in I a^{H}ⱼ+a^{S}ⱼ>

Note that generalized similarity is computed using both soft and hard synaptic maps. A hard similarity can also be computed by using only hard synaptic maps. Likewise, a soft similarity can be computed using only soft synaptic maps.

If a label importance matrix L is available, then similarity becomes,

Sᵢⱼ=1/Nₐ<u^{H}ᵢ+u^{S}ᵢILIIa^{H}ⱼ+a^{S}ⱼ>

To find ads with the highest similarity to push out to user i, the following algorithm is employed:
1. The hard similarity is computed for all new ads.
2. Any similarities below the threshold S^{T}ᵢ are thrown out, where S^{T}ᵢ represents the threshold cut-off for user i which is a function of the user's digital valve setting (e.g. fewer high relevance ads vs. more less relevant ads).
3. The resulting similarity metric set {S} is sorted in descending order.
4. The Top N ads are selected and pushed to user. if no ads remain in the set, the algorithm is recomputed using the generalized similarity metric instead.

Mathematical Model—Synatic Learning Algorithm

The synaptic learning algorithm is applied once an ad is delivered to a user. It principally learns about both user preferences and ad attributes by modifying a user's soft synaptic map and an ad's soft synaptic map.

Its other major function is to “harden” soft labels by promoting them into the hard synaptic map from the soft synaptic map.

After ad j is pushed to user i, the following algorithm is applied:

Sᵢⱼ=1/Nₐ<u^{H}ᵢ+u^{S}ᵢILIIa^{H}ⱼ+a^{S}ⱼ>

I u^{S}ᵢ=IÎ−α><u^{S}ᵢI±Iα><a^{H}ⱼI

Where Î=(1,1,1, . . . )^{T} and

Where Iα>=c/aⱼₖ I a^{H}ⱼ> with c≦1 and

With ark is the k^{th} element of a^{H}ⱼ

This process modifies all label in the synaptic map for user i that appear in the synaptic map of ad j. As a result, the synaptic map of ad j is imprinted faintly on user i.

In this equation, the vector |α> represents the learning rate. Its numerical values depend on the type of action taken by the user (explicit rating, ignored push, view, click-through, etc). If the action is positive (user thought the ad was relevant) then it is an additive equation. If the action is negative then it is a subtractive equation.

In addition to modifying the user soft synaptic map, the ad soft synaptic map is also modified using a similar technique:

Ia^{s}ⱼ>=IÎ−α><a^{s}ⱼI±I α><u^{H}ᵢI

After each application of the synaptic learning algorithm or in batch, the last phase is to examine any soft labels that are candidate for hardening or unhardening.

Any soft labels with synaptic weight IwₖI>T^{H} are hardened to either +1 or −1 and represent a learned label. Any previously hardened labels with synaptic weight IwₖI<T^{L} are unhardened and represent forgotten but previously learned label.

Parameters T^{H} and T^{L} represent promotion and demotion thresholds respectively. They are tuning parameters of the algorithm that indicate how quickly new labels are learned and forgotten. Fundamentally they dictate the system trade-off between prediction accuracy and prediction latency.

Enabling Learning via Staged Delivery

It is not valuable to deliver ads to all users immediately as it does not give the system a chance to learn about the relevance of the ad. Therefore the system will build in staged delivery concepts as follows:
(1) Ads will be delivered first to users with high resonance.
(2) Based on responses, the ad labels will be strengthened or weakened via resonance,
(3) Ads will then be delivered to users with next highest resonance, for new ad map.

Steps 1-3 will repeat so long as the ad is deemed relevant to users.

For example, an ad could be delivered to the top 1 percent of users with the highest resonance. Based on these users' receptivity to the ad (as measured by click-through rates, page-views, etc.), the ad could then be unrolled to a larger percentage of users.

Semantic Equivalencies

Second-order analysis can be performed on Label Synaptic Maps to derive semantic equivalents. This will be done to improve the usability and intelligence of the engine. For example, if “house” and “music” are very highly correlated, a semantic equivalent to “house music” will automatically be generated

### EXAMPLE 2

### Lottery System

Description of Lottery System
(1) Tickets are awarded for different actions determined by the system, including:
(2) Responses to ads
(3) Responses to survey questions attached to ads
(4) Updating a User Synaptic Map
(5) Inviting friends to the systems

Specific Description of How Lottery System Awards Tickets

Tickets earned for different actions may be entered into different incentive prize draws. The implication is that the Lottery system must have a way of differentiating tickets awarded for different actions. One method of differentiating tickets is to use a taxonomic system that generates unique identifiers for each ticket. For example, a ticket number may consist of a string of numbers and/or letters that encode information such as: unique user identification number, the date on which tickets were awarded, type of action user was engaged in when the ticket was awarded, etc.

For example, the ticket number may look like “012345-20060708-154”, where “012345” is the unique user identification number, “120060708” is the date on which the ticket was awarded, and “154” was the action the user was engaged in to earn the ticket.

Description of How Prizes are Awarded

Prize draws may follow the standard format where a winning ticket is randomly selected from all of the eligible tickets for the draw. For examples only the tickets awarded for engaging in a certain action may be eligible for a particular prize draw.

If a user possesses a winning ticket, he or she may be contacted to verify a shipping address for delivery of a prize.

Advantages of Lottery System Coupled with Relevance Engine

When the user submits his or her address information for the purposes of claiming a prize, this allows the system to verify that the user's address information is valid and correct (it is well known that users often submit false addresses in order to conceal their identities or remain anonymous; this can reduce the effectiveness of other reward systems).

As a method of incenting users to take particular actions, users may be rewarded with lottery tickets. Multiple tickets can be awarded for each action. Actions that provide rewards will be determined dynamically by the relevance engine, based on actions it would like a user to take.

Dealing with Stale Data

In addition to incenting users to use the system, the lottery can be also be used for the purpose of incenting users to take actions that positively impact the relevance engine. For example, if a user has not recently reviewed her User Synaptic Map, the system may incent her by offering a large number of lottery tickets.

To deal with stale or inaccurate data, the system will employ self-correcting algorithms that periodically scan for bad or unknown data (ads, users, etc.). To better qualify that bad or unknown data, the system will entice users to provide feedback via lottery ticket offers attached to actions.

Flow Rate

In the proposed system, the rate at which ads are delivered to the user is fully under user control. This flow rate is controlled by a digital valve that can be adjusted by the user to match his or her preferences. The flow rate is also a learned quantity that the system can fine-tune in response to a user's change in behavior. For example, the user could set the delivery of content to three times a week instead of twice a week.

Tweaking the Learning Rate

It is proposed that the system learn about the user by assemblies sets of Synaptic Maps. Much like normal human beings however, the rate at which effective neuron connections are strengthened or weakened (forgotten) depends very much on the how quickly an individual user consumes ads.

For example, a user that consumes 10 ads every week should learn faster and forget faster than a user that consumes 2 ads every week. Therefore, in our invention, the learning rate is proportional to the flow rate of ads to the user.

### EXAMPLE 3

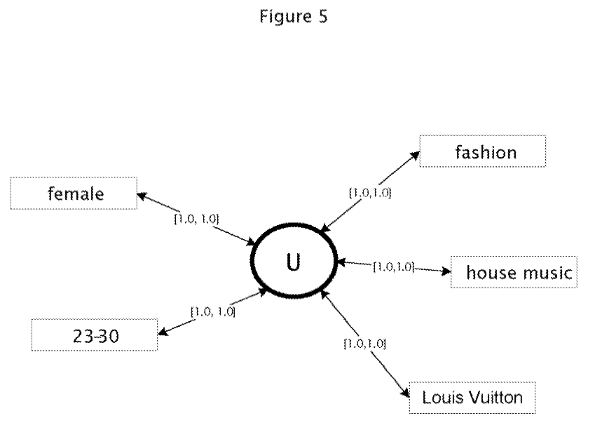

### FIG. 5

### User Synaptic Map Evolution

Consider User A that has just begun to use the system. As a starting point, she enters the following labels to describe her preferences in a User Synaptic Map.

Assuming the system already has a developed a set of Label Synaptic Maps, User A's User Synaptic Map would be extended by resonance with a set of Label Synaptic Maps.

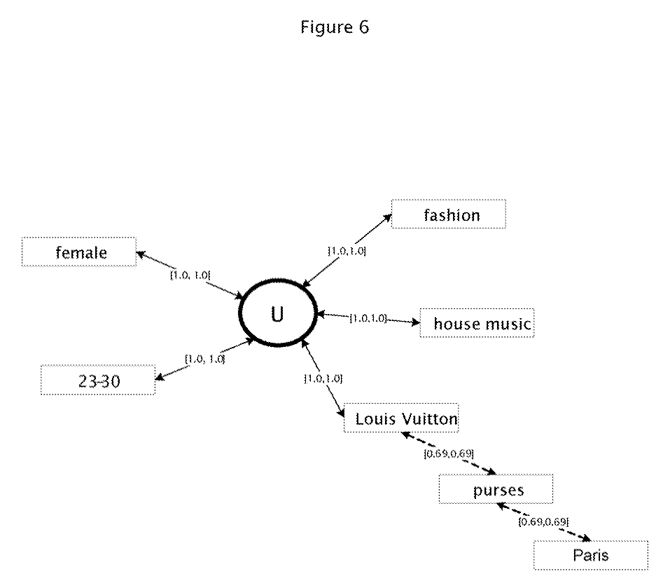

This would create a virtual User Synaptic Map that looks as FIG. 6.

Notice that the system understands how to extend a user's map by leveraging a label map, in this example, the system has made a second order inference that User A is interested in purses due to her liking of Louis Vuitton. In addition, the system has a weaker third order inference that she may have in interest in Paris, France.

Over time t, user receives N ads that resonate with her preference. Of the N ads, she responds (clicks) to M of them. Of those M responses, m are strong favorable and (M-m) are not favorable,

This implies that:
(1) M ads were strongly favorable
(2) (M-m) ads were strongly unfavorable
(3) (N-M) ads were weakly unfavorable, or not interesting enough to click-thru

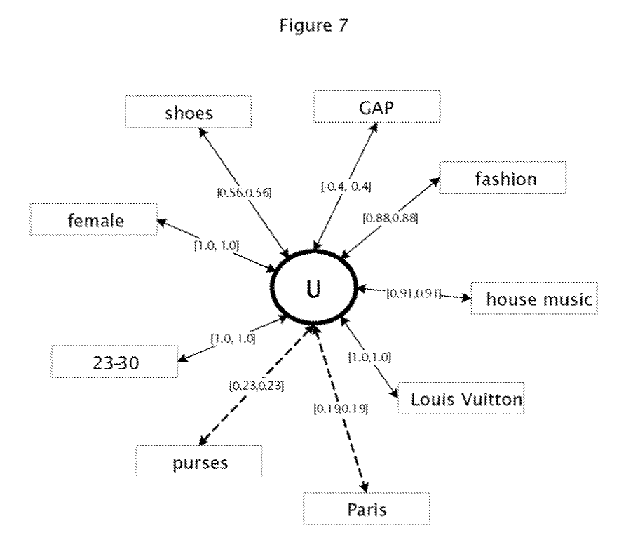

Let Δt represent the time interval over which a single response occurs. Then, after each Δt, the user's synaptic map is modified via resonance with ad responded to within that interval. In this example, after N ads, User A's synaptic map becomes as shown in FIG. 7.

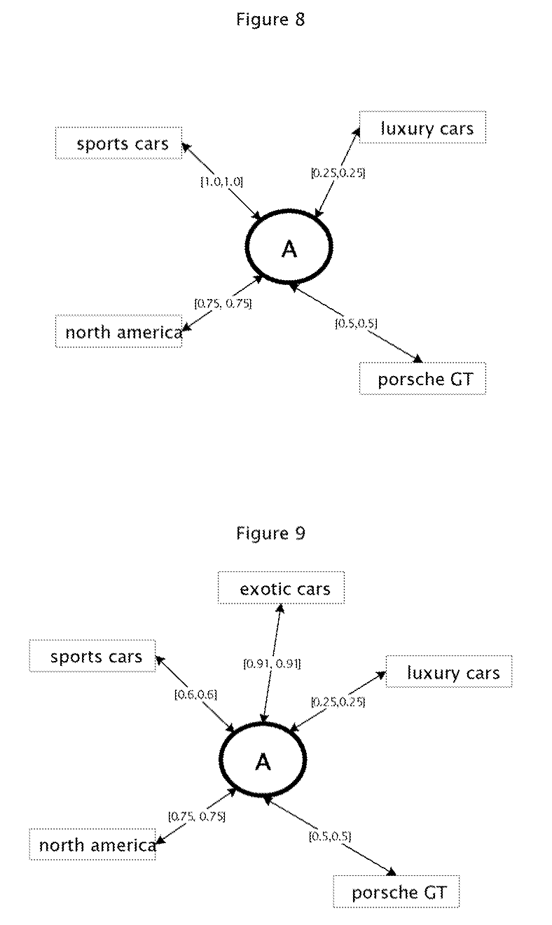

Notice that the synaptic weights between User A's original map shown in FIG. 1 and the final map shown in FIG. 8 have been adjusted via resonance with the N delivered ads.

The process of resonance with the N ads has also added new labels based on common occurrences in viewed ads. Also, some negative labels have appeared based on labels contained in unfavorable responses.

### EXAMPLE 4

### Ad Synaptic Map Evolution Advertiser submits Ad X (a new ad) to the Gazaro network (or alternatively, Gazaro crawler finds an ad via search or syndication) Initial synaptic map looks like FIG. 8.

The initial ad map shown in FIG. 8 is derived based on input by the advertiser and based on scanning the ad content. Following the staged delivery method, the ad is delivered to the first stage of users with the highest resonance. Depending on the responses of those users, the synaptic map begins to evolve due to the resonance process. For example, if all users that responded had a stronger interest in “exotic cars” rather than “sports cars”, the map would evolve to look like FIG. 9.

Notice that the map has evolved to include the “exotic cars” classification and has reduced the strength of the weighting to the “sports car” label. This reflects the fact that the ad is better classified under the “exotic cars” label than the “sports cars” label,

### EXAMPLE 5

### Deriving Label Synaptic Maps

Consider an evolved Ad Synaptic Maps after resonance with a large set of responders as shown in FIG. 9. As the Ad is now evolved, we can use it to derive similarities between labels.

For example, we can say that “Porsche GT” and “exotic cars” have a similarity of 0.91×0.5=0.455 for this ad.

To derive a Label Synaptic Map over N ads, this can be generalized as follows:

S(wᵢ,wⱼ)=Σ_{N}wᵢ,wⱼ/N, N={Users Vwᵢ≠0}

That is, the similarity of two labels is given by the function S which indicates the strength of the similarity in the sample set. The default sample set is all users where either wᵢ or wⱼ are non-zero. Note that exact form of the similarity function can be tweaked depending on use. A single form of the equation is shown here.

Instead of similarities, we can also derive a Label Synaptic Map of label correlations. This is done by using User Synaptic Maps, instead of Ad Synaptic Maps as above.

Consider the example shown in FIG. 7. From that evolved synaptic map, we can postulate a correlation between users that like Louis Vuitton and users that are female. The strength of that correlation for the user in this example is 1.0×1.0=1.0.

To derive a Label Synaptic Map over N users, this can be generalized as follows:

C(wᵢ,wⱼ)=Σ_{N}wᵢ,wⱼ/N, N={Users Vwᵢ≠0 or wⱼ≠0}

That is, the correlation of two labels is given by the function C which indicates the strength of the correlation over the sample set. The default sample set is all users where either wᵢ or wⱼ are non-zero. Note that exact form of the similarity function can be tweaked depending on use. A single form of the equation is shown here.

### EXAMPLE 6

### Multi-Modal Delivery, Presences and Location

Beyond email, the system can deliver ads over any communication channel so a user could direct ads via RSS, mobile SMS/MMS, SIP, voice channels, or other content distribution channels. For example, the user could direct all ads to their RSS reader or mobile phone.

The system could also intelligently decide when to route messages to different mediums by learning about user behavior or incorporating user presence from mobile networks, instant messaging networks, calendars, phone activity, or other sources of presence information. For location sensitive ads, the system could leverage location (GPS) services to intelligently route ads of interest to users in specific areas For example, if the system knows that User X has a strong interest in clothes from Store Y, then the system could direct ads from Store Y via SMS/MMS to that user when in the vicinity of Store Y.

Although the description above contains much specificity, these should not be construed as limiting the scope of the invention but as merely providing illustrations of some of the presently preferred embodiments of this inventions. Thus the scope of the invention should be determined by the appended claims and their legal equivalents,

What is claimed is:

1. A relevance engine for delivering increasingly relevant advertising content to a user comprising:
a. Means for said user access to said relevance engine;
b. Means for submitting information about the user to the engine;
c. Means for determining relevant advertisement to deliver to the user;
d. Means for delivering relevant advertising content to the user; and,
e. Means for tracking user dynamic response to said delivered advertising content.

2. The relevance engine of claim 1 wherein said means for user access comprises an Internet portal.

3. The relevance engine of claim 2 wherein said means for submitting information about the user to the engine comprises a plurality of interactive fields displayed on said Internet portal and comprising at least an e-mail field for entering the user's e-mail address.

4. The relevance engine of claim 3 wherein said plurality of interactive fields includes the following fields: age, sex, occupation, explicit preferences to ad content and a set of participant generated taxonomic keywords.

5. The relevance engine of claim 4 wherein the plurality of interactive fields further includes a field whereby the user can identify with a predefined demographic group.

6. The relevance engine of claim 5 wherein said set of user generated taxonomic keywords includes a set of folksonomy tags to attract relevant ad content to the user.

7. The relevance engine of claim 6 wherein said means for tracking dynamic user response comprises clickthrough rates, response time and the time of day.

8. The relevance engine of claim 7 wherein the means for tracking dynamic user response further comprises means for the user to weight the relevance of each ad viewed by the user.

9. The relevance engine of claim 8 wherein said means for delivering relevant advertising content to the user comprises a user operated digital valve adapted to regulate ad flow to the user at a predetermined rate.

10. The relevance engine of claim 9 wherein means for tracking user dynamic response to said delivered advertising content comprises a user reward system adapted to promote a desired user response to an ad.

11. A relevance engine for delivering increasingly relevant advertising content to a user comprising:
a. A set of folksonomy elements for generating an open-ended natural language taxonomy of labels for identification of relevant ads;
b. A set of taxons for creating groups of said labels;
c. A set of identity elements for the identification of system elements, wherein said system elements comprise users, ads and advertisers;
d. A first input comprising a set of user synaptic maps for mapping weighted relationships between users and the taxons, and between users and labels, wherein each user synaptic map relates a user to a set of labels;
e. A second input comprising set of ad synaptic maps for mapping weighted relationships between ads and taxons, and between ads and labels;
f. A first output comprising a set of label synaptic maps for mapping weighted relationships between the labels and said taxons;
g. A second output comprising a set of advertiser synaptic maps for mapping weighted relationships between advertisers and labels, and between advertisers and taxons
h. Means for computing a degree of resonance between at least two synaptic maps,
i. Means for delivering relevant ads to the user based on said degree of resonance; and,
j. A user feedback mechanism.

12. The relevance engine of claim 11 wherein said user synaptic map comprises said user identity and a set of folksonomy elements representative of user ad interests, and wherein each ad interest is weighted from a value of “−1” to “+1” with positive values being excitory and negative values being inhibiting so that a correlation between users having common interests may be established.

13. The relevance engine of claim 12 wherein said ad synaptic map comprises an ad identity and a set of folksonomy elements representative of ad identity elements, and wherein each ad identity element is weighted from a value of “−1” to “+1” with positive values representing a high resonance between the user and the ad and with negative values representing a low resonance level between the user and the ad so that a correlation between various ad identity elements may be established.

14. The relevance engine of claim 13 wherein said advertiser synaptic map comprises a compilation of successive ad synaptic maps corresponding to the same advertiser thereby indicating which ad identity elements have the strongest user resonance.

15. The relevance engine of claim 14 wherein said label synaptic map comprises a compilation of a plurality of user synaptic maps and ad synaptic maps so that the resonance strengths between labels may be established.

16. A relevance engine for delivering increasingly relevant advertising content to a user comprising;
a. First means for computing the similarity between a first synaptic map and a second synaptic map; and,
b. Second means for determining user preferences and ad attributes.

17. The relevance engine of claim 16 wherein said first synaptic map is a user synaptic map comprising a first user synaptic map representing user hard preferences and a second user synaptic map representing user soft preferences.

18. The relevance engine of claim 17 wherein said second synaptic map is an ad synaptic map comprising a first ad synaptic map representing ad hard preferences and a second synaptic map representing ad soft preferences.

19. The relevance engine of claim 18 wherein said first means for computing the similarity between a first synaptic map and a second synaptic map comprises a resonance algorithm.

20. The relevance engine of claim 19 wherein said second means for determining user preferences and ad attributes comprises a synaptic learning algorithm adapted to learn user preferences from the user soft synaptic map and the ad soft synaptic map.
